(19) United States
(12) Patent Application Publication
(10) Pub. No.: US 2010/0043657 A1
(43) Pub. Date: Feb. 25, 2010

(54) Method for Operating a Damping System, Damping System, and Printing Group

(75) Inventor: Thomas John, Augsburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: MANROLAND AG, Offenbach am Main (DE)

(21) Appl. No.: 12/515,705

(22) PCT Filed: Nov. 22, 2007
(86) PCT No.: PCT/EP2007/010136

§ 371 Date: May 20, 2009

(30) Foreign Application Priority Data
Nov. 24, 2006 (DE) 10 2006 055 584.8

(51) Int. Cl. B41L 25/00

(52) U.S. Cl. 101/148

(57) ABSTRACT

A method for operating a dampening system of a printing group of a printing machine, especially a web-fed rotary printing press, the dampening system comprising a dampening means dosing device provided with a plurality of dosing units, a dampening system rolling mill drive having at least one dampening system roller, and at least one dampening means application roller. The application of the dampening means is adapted to the width of the material to be printed or to widths of the sides of the material to be printed.

### CROSS REFERENCE TO RELATED APPLICATIONS

This is a U.S. National stage of International Application No. PCT/EP2007/010136, filed on 22 Nov. 2007. Priority is claimed on German Application No. 10 2006 055 584.8, filed on 24 Nov. 2006, the content of both being incorporated herein by reference.

### BACKGROUND OF THE INVENTION

1. Field of the Invention

The present invention pertains to a method for operating a dampening unit of a printing couple of a printing press. The invention also pertains to a dampening unit and to a printing couple.

The printing couples of printing presses have a form cylinder, a transfer cylinder that rolls on the form cylinder, an impression cylinder that rolls on the transfer cylinder, an inking couple, and a dampening unit. The inking couple is used to transfer printing ink to the form cylinder, to at least one printing form positioned thereon, which carries the page to be printed. With the help of the dampening unit, dampening solution can be applied to the printing form or forms arranged on the form cylinder. The form cylinder is also called a “plate cylinder”.

At least one blanket positioned on the transfer cylinder transfers the ink to a substrate, where the substrate can be moved through a nip formed between the transfer cylinder and the impression cylinder. The transfer cylinder is also called a “blanket cylinder”.

In the case of web-fed rotary printing presses, several printing couples are usually combined into a printing unit, where, in this case, the impression cylinder of a printing couple of a printing unit is designed either as a so-called “satellite cylinder”, which rolls on several transfer cylinders of different printing couples of the printing unit, or as a transfer cylinder of a different printing couple of the printing unit.

The dampening unit is used to apply dampening solution to the printing form or to each printing form positioned on the form cylinder, where a dampening unit comprises a dampening solution metering device comprising several metering units; the metering device applies dampening solution to a dampening roller of a dampening roller train directly downstream of the dampening solution metering device. The dampening roller or each dampening roller of the dampening roller train conveys the dampening solution to at least one dampening form roller, which rolls on the form cylinder and thus ultimately applies the dampening solution to the printing form or to each printing form positioned on the form cylinder.

The application of the dampening solution to the printing form on to each printing form positioned on the form cylinder must be adapted to the width of the pages to the printed in order to ensure optimum print quality. It should be noted that a printing form can be used for the printing of one or more pages. When a printing form is used to print several pages, these several pages can be arranged either next to each other in the axial direction of the form cylinder or one behind the other in the circumferential direction.

In cases where it is desired to produce different printed products which differ with respect to the width of the pages to be printed or with respect to the width of the substrate to be printed, the application of the dampening solution presents difficulties with respect to optimum print quality.

### SUMMARY

The present invention relates to creating a novel method for operating a dampening unit of a printing couple, a novel dampening unit, and a novel printing couple in order to make optimum print quality possible.

The application of the dampening solution is adapted to the width of the substrate or to the widths of pages to be printed on the substrate.

In accordance with one embodiment of the present invention, the application of dampening solution of a dampening unit is adapted to the width of the substrate or to the widths of the pages to be printed. As a result, it is possible to achieve optimum print quality.

### BRIEF DESCRIPTION OF THE DRAWINGS

Preferred elaborations of the invention can be derived from the subclaims and from the following description. Exemplary embodiments of the invention, which are not intended to limit the invention, are explained in greater detail below on the basis of the drawings:

FIG. 1 is a schematic diagram of a printing couple;

FIG. 2 is a form cylinder of a printing couple with four printing forms arranged on the form cylinder for the printing of relatively wide pages;

FIG. 3 is a form cylinder of a printing couple with four printing forms arranged on the form cylinder for the printing of relatively narrow pages;

FIG. 4 is a schematic top view of part of an inventive dampening unit according to a first exemplary embodiment of the invention in the area of a dampening solution metering device and of a dampening roller directly downline therefrom;

FIG. 5 is a side view of the part shown in FIG. 4;

FIG. 6 is a schematic top view of part of an inventive dampening unit according to a second exemplary embodiment of the invention in the area of a dampening solution metering device and of a dampening roller immediately downstream thereof;

FIG. 7 is a side view of the part shown in FIG. 6;

FIG. 8 is a detail of the part shown in FIG. 6;

FIG. 9 is a schematic view, similar to that of FIG. 7, of part of an inventive dampening unit according to a third exemplary embodiment of the invention;

FIG. 10 is a detail of the part shown in FIG. 9;

FIG. 11 is a schematic top view of part of an inventive dampening unit according to a fourth exemplary embodiment of the invention in the area of a dampening solution metering device and of a dampening roller arranged directly downstream thereof;

FIG. 12 is a side view of the part shown in FIG. 11;

FIG. 13 is a perspective side view of an alternative to the part shown in FIG. 12;

FIG. 14 is an edge section of an inventive dampening unit in a first state, and

FIG. 15 is the edge section of FIG. 14 in a second state.

### DETAILED DESCRIPTION OF THE PREFERRED EMBODIMENTS

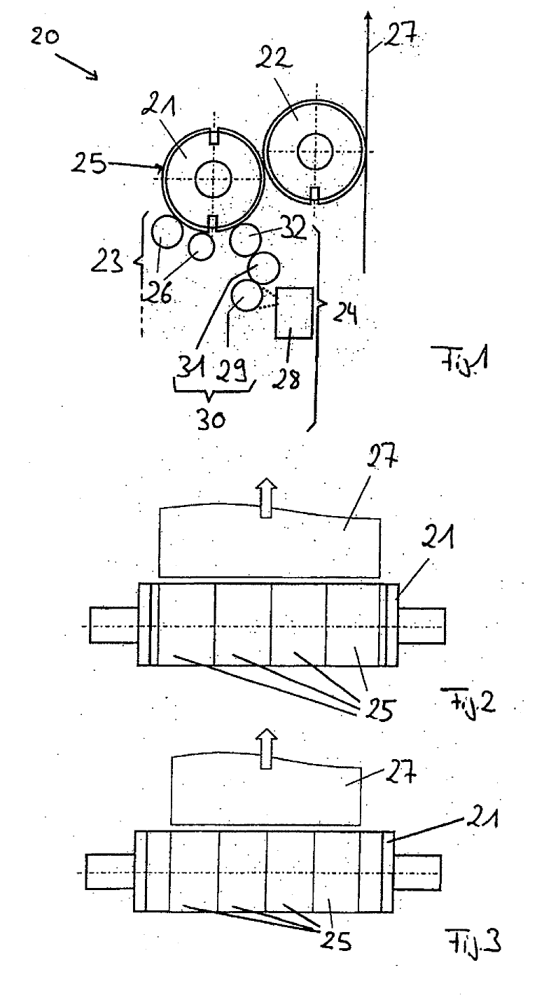

FIG. 1 is the basic design of a printing couple 20 of a printing unit of a web-fed rotary printing press in highly schematic fashion, where the printing couple 20 comprises a form cylinder 21, a transfer cylinder 22, an inking couple 23, and a dampening unit 24. On the form cylinder 21 of the printing couple 20 shown in FIG. 1, several printing forms 25 are arranged. The inking couple 23 is used to apply printing ink to the printing forms 20 arranged on the form cylinder 21 and the dampening unit 24 is used to apply dampening solution to printing form 25. Only the ink form rollers 26 of the inking couple 23 are shown; these are the rollers which roll on the form cylinder 21. With the help of the transfer cylinder 22, over which at least one blanket has been pulled, the ink applied to the printing forms 25 is applied to a substrate 27 to be printed, where, for this purpose, an impression cylinder (not shown) cooperates with the transfer cylinder 22.

The dampening unit 24 has a dampening solution metering device 28, which comprises several metering units (not shown in FIG. 1). With the help of the metering units of the dampening solution metering device 28, dampening solution is applied to a dampening roller 29 of a dampening roller train 30. In the exemplary embodiment shown here, the dampening roller train 30 comprises a total of three dampening rollers, namely, the dampening roller 29 directly downstream of the dampening solution metering device 28, a dampening roller 31 rolling on this dampening roller 29, and a dampening form roller 32, which rolls on the form cylinder 21 and thus ultimately applies the dampening solution to the printing forms 25 arranged on the form cylinder 21.

FIGS. 2 and 3 show the form cylinder 21 of a printing couple 20 in isolation, where four relatively wide printing forms 25 are arranged axially next to each other on the form cylinder 21. According to FIG. 3, four relatively narrow printing forms 25 are arranged next to each other on the form cylinder 21 in the axial direction of the cylinder. It can be seen from a comparison of FIG. 2 with FIG. 3 that the width of the substrate 27 which is printed changes as a function of the width of the printing forms 25. In the following, it will be assumed that each of the printing forms 25 serves for the printing of one page on the substrate 27 in question.

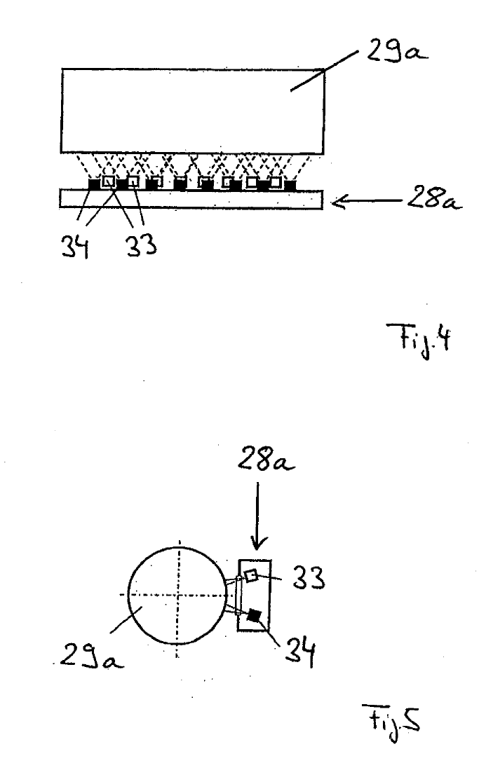

To ensure optimum print quality, dampening solution is applied by a dampening unit 24 of a printing couple 20 to the printing forms 25 positioned on the form cylinder 21 of the printing couple 20. This is done according to one embodiment of the invention in such a way that the dampening solution application is adapted to the width of the substrate 27 which will be printed or to the width of the pages to be printed on the substrate 27. For this purpose, the dampening units described below in greater detail with reference to FIGS. 4-15.

FIGS. 4 and 5 show schematic diagrams of part of an inventive dampening unit according to a first exemplary embodiment of the invention in the area of a dampening solution metering device 28a and a dampening roller 29a located directly downstream of the dampening solution metering device 28a. In the exemplary embodiment of FIGS. 4 and 5, the dampening solution metering device 28a comprises several metering units 33 and 34 for dampening solution. All of the metering units 33 and 34 are designed to be stationary with respect to the dampening unit roller 29a located directly downstream of the dampening solution metering device 28a. To adapt the dampening solution application to the printing width and/or to the widths of the pages to be printed on the substrate, the metering units 33 and 34 of the dampening solution metering device 28a are individually controllable such that, depending on the substrate width and/or the width of the pages, a first subset of metering units is active and a second subset of metering units is inactive.

In the exemplary embodiment of FIGS. 4 and 5, the metering units form two groups, namely, a first group of metering units 33 and a second group of metering units 34. Each of these two groups of metering units is adapted to a different substrate width and thus to a different page width. Within each group, the metering units 33 and 34 in question are arranged next to each other in the axial direction. As can be seen in FIG. 5, in this exemplary embodiment the metering units 33 and 34 of the different groups are arranged so that one group is above the other, namely, on a circular arc, so that all metering units 33 and 34 are the same distance away from the dampening unit roller 29a.

In the exemplary embodiment of FIGS. 4 and 5 shown here, the metering units 33 are used to apply dampening solution when, on the form cylinder 21 according to FIG. 3, relatively narrow printing plates with relatively narrow pages are arranged. When, however, relatively wide printing plates for relatively wide pages are arranged on the form cylinder 21, the dampening solution is applied by means of the metering units 34 of the dampening solution metering device 28a.

In the exemplary embodiment of FIGS. 4 and 5, the metering units 33 and 34 are designed as nozzle units, where two nozzle units are provided per page width to be printed. With the help of these nozzle units, dampening solution can be sprayed discontinuously onto the dampening roller 29a.

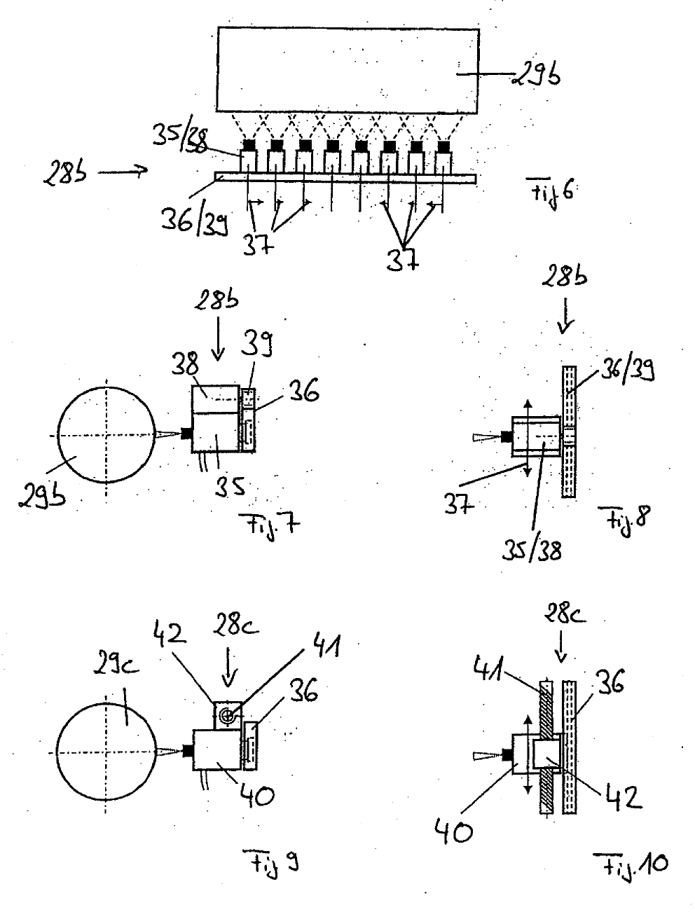

FIGS. 6-8 show schematic diagrams of part of a dampening unit according to a second embodiment of the invention. FIGS. 6 and 7 show a dampening solution metering device 28b and a dampening roller 29b located directly downline from the dampening solution metering device 28b. In the embodiment of FIGS. 6-8, the dampening solution metering device 28b has several metering units 35 for dampening solution. At least one of these metering units 35 and preferably all of the metering units 35 are designed to be movable relative to the dampening roller 29b in the axial direction thereof.

For this purpose, the metering units 35 are supported movably on a guide rail 36. To adapt the dampening solution application to the substrate width or to the page width, all of the movable metering units 35 are controllable individually in such a way that at least one of the movable metering units 35 changes its position relative to the dampening unit roller 29b in the axial direction thereof when there is a change in the substrate width or in the page width. Thus, in FIG. 6, displacements of the metering units 35 in the axial direction of the dampening unit roller 29b are shown by the arrows 37, as a result of which the dampening unit is adapted to decreasing page widths or to decreasing substrate width.

In the embodiment of FIGS. 6-8, a separate drive 38 is assigned to each metering unit 35 of the dampening solution metering device 28b, so that each of the metering units 35 can be moved by its own motor along the guide rail 36. For this purpose the drive 38 works together with a drive pinion 39.

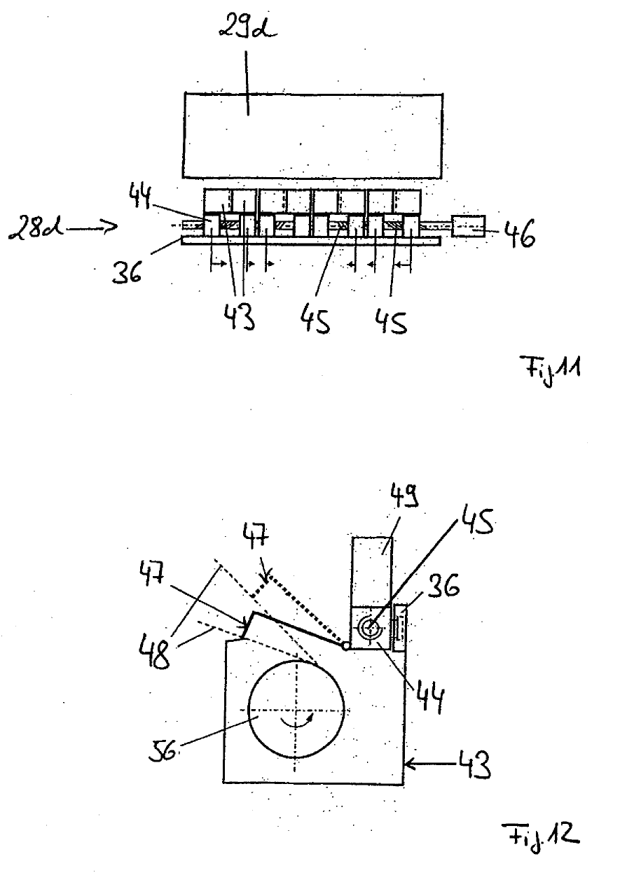

In contrast to the exemplary embodiment of FIGS. 6-8, it is also possible according to a third exemplary embodiment of the present invention according to FIGS. 9 and 10 to assign a common drive to several, preferably all, movable metering units 40 of a dampening solution metering device 28c in order to move the metering units 40 in the axial direction of the dampening roller 29c.

The drive (not shown in FIGS. 9 and 10) then preferably drives a threaded rod 41, where the threaded rod 41 cooperates with the appropriately threaded carriers 42 of the metering units 40. Preferably the threaded rod 41 comprises individual threaded rod sections—individual, that is, with respect to the direction of the thread and/or its pitch—for at least some of the metering units 40, preferably for all of the units. The metering units 40 are supported on these individual sections by the carriers 42 comprising the corresponding counterthread. By changing or adapting the direction of the thread, the metering units 40 can be made to travel in different directions. Through the use of threads with different pitches, the same rotation of the threaded rod 41 for actuating the metering units 40 can produce different translational adjusting movements of the metering units 40.

In the exemplary embodiments of FIGS. 6-10, the metering units are again designed as spray units. Because, in the case of dampening units with spray units, the ratio of the overlap of the various spray cones to their distance from the dampening roller located directly downstream of the dampening solution metering device is important, a radial component of the adjusting movement can be superimposed on the axial displacement of the metering units.

In the exemplary embodiments of FIGS. 1-10, spray units are used as metering units, by means of which, as already explained, dampening solution is sprayed preferably discontinuously onto the dampening roller located directly downstream of the dampening solution metering device.

In contrast, FIGS. 11-13 show exemplary embodiments of the present invention in which the metering units of the dampening solution metering devices in question are designed as whirlers, by means of which dampening solution is flung off continuously by centrifugal force and thus applied to the dampening roller located directly downstream of the dampening solution metering device in question.

FIGS. 11 and 12 show part of an inventive dampening unit according to a fourth embodiment of the present invention, again in the area of a dampening solution metering device 28d and a dampening roller 29d located directly downstream of the dampening solution metering device 28d. The dampening solution metering device 28d again has several metering units 43, where each of the metering units 43 is supported on a threaded rod 45 by way of a carrier 44. A drive 46, which drives the threaded rod 45 and thus shifts all of the metering units 43 of the dampening solution metering device 28b jointly, is assigned to the threaded rod 45. To this extent the exemplary embodiment of FIGS. 11 and 12 is the same as that of FIGS. 9 an 10, so that with respect to these details reference can be made to the explanation given above.

In the exemplary embodiment of FIGS. 11 and 12, the metering units 43 are designed as whirlers, where all of the metering units 43 comprise a common rotor 56, by means of which dampening solution can be flung toward the dampening unit roller 29d. Each metering unit 43 has a shutter 47, by means of which the quantity of dampening solution can be adjusted. FIG. 12 shows a shutter 47 in two different positions, namely, in a closed position, in solid line, and in an open position, in dotted line, where, when the shutter 47 is open, the dampening solution is flung onto the dampening unit roller 29d in the form of a cone 48. A drive 49 is assigned to each metering unit 43 to open and to close the shutter 47. Preferably two metering units 43, designed as whirlers, work together per page width, where the shutters 47 of the cooperating metering units 43 overlap.

To adapt the dampening solution metering device 28d to a change in page width or to a change in substrate width, the metering units 43 cooperating with each other for each page width and can be moved relative to each other, where for this purpose at least one of the two cooperating metering units 43 or possibly each of them can be moved in the axial direction of the dampening unit roller 29d.

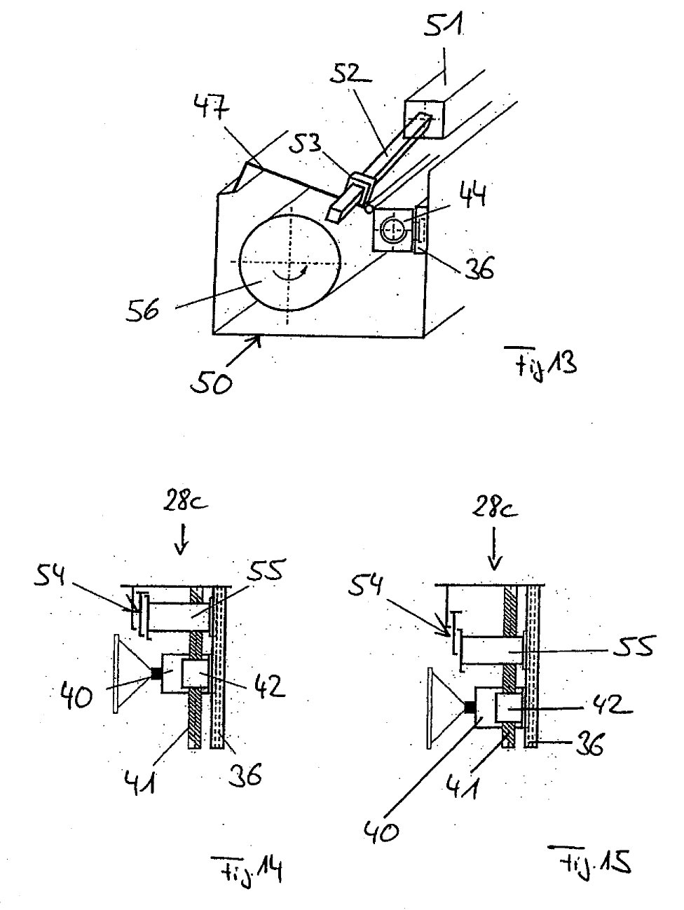

FIG. 13 shows a metering unit 50 representing an alternative to the metering unit 43 shown in FIG. 12. This alternative unit is again designed as a whirler. In the case of the metering unit 43 of FIG. 12, the drive 49 for actuating the shutter 47 can be moved together with the metering unit 43. In the case of the metering unit 50 of FIG. 13, however, a drive 51, which serves to actuate the shutter 47, is stationary, where the drive 51 is connected to the shutter 47 to be actuated by a flexible shaft 52 and a coupling or clutch 53. As a result, axial compensation can be achieved between the stationary drive 51 and the shutter 47, which can shift position axially together with the metering unit 50.

FIGS. 14 and 15 show part of the drive unit of the exemplary embodiment of FIGS. 9 and 10 in the area of the edge of the corresponding dampening solution metering device 28c for the purpose of making it clear that the edge sections of the dampening solution metering device adjacent in the axial direction to the outer metering units 40 can be at least partially blocked off. As a result, it can be guaranteed that no dampening solution or only a reduced amount of dampening solution will arrive on the form cylinder in question to the left and/or to the right of the substrate to be printed. So that this blocking in the edge areas can be adapted to different substrate widths or page widths, it must be designed to be movable.

Thus FIGS. 14 and 15 show an edge blocker 54 of the dampening solution metering device 28c. It is designed in telescoping fashion as shown in FIGS. 14 and 15. In the exemplary embodiment shown, the telescope-like edge blocker 54 has three segments, which can shift their positions relative to each other.

One of the segments is stationary, whereas the other two segments are movable. By way of a carrier 55, one of the segments of the telescoping edge blocker 54 is supported on the threaded rod 21, where this carrier 55 has a counterthread corresponding to the threaded rod 41. The use of a telescoping edge blocker 54 is advantageous for space reasons. It is also possible, however, to use a roll-like blocker.

The present invention can be applied in all cases in which a dampening unit must be adapted to changes in substrate widths or to changes in page widths. When there is a change in the width of a substrate to be printed, the corresponding printing couple of the printing press can run the substrate either the cylinder center or flush with one side of the machine.

All of the motorized adjustments of the dampening units can be conducted automatically on the basis of presettings stored in the printing press.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A method for operating a dampening unit of a printing couple of a printing press, the dampening unit comprising:
a dampening solution metering device having a plurality of metering units;
a dampening roller train having at least one dampening roller, the dampening roller train configured to be dampened by the dampening solution metering device; and
at least one dampening form roller coupled to the dampening roller train, the method comprising:
adapting an application of the dampening solution to the dampening roller train based on at least one of a width of a substrate or widths of pages to be printed on the substrate.

18. A dampening unit of a printing couple of a web-fed rotary printing press, the dampening unit comprising:
a dampening roller train, the dampening roller train comprising at least one dampening roller;
a dampening solution metering device configured to apply dampening solution to the at least one dampening roller, the dampening roller located directly downstream of the dampening solution metering device, the dampening solution metering device comprising a plurality of stationary metering units relative to the dampening roller;
at least one printing form positioned on a form cylinder; and
at least one dampening form roller configured to convey the dampening solution from the dampening roller train to the at least one printing form,
wherein the plural metering units are configured for individual control such that a first subset of the plural metering units is active and a second subset of the plural metering units is inactive, based at least in part on the substrate width or the width of the pages to be printed on the substrate to adapt the application of the dampening solution to a substrate width or to a widths of pages to be printed on the substrate.

19. The dampening unit according to claim 18, each of the plural metering units in at least one of the first subset of plural metering units and the second subset of plural metering units are arranged next to each other longitudinally with respect to the substrate width or the width of the pages to be printed on the substrate.

20. The dampening unit according to claim 19, wherein the first subset of plural metering units and the second subset of plural metering units are arranged on a circular arc such that all of the metering units are a same distance from the dampening roller

21. A dampening unit of a printing couple of a web-fed rotary printing press, the dampening unit comprising:
a dampening solution metering device configured to apply dampening solution to a dampening roller of a dampening roller train located directly downstream of the dampening solution metering device, the dampening solution metering device comprising a plurality of metering units, and
at least one dampening form roller configured to convey the dampening solution from the dampening roller train to at least one printing form,
wherein at least one of the plural metering units is configured to be movable relative to the dampening roller, and
to adapt application of the dampening solution to a substrate width or to a width of pages to be printed on the substrate, the movable metering unit is individually controllable such that the at least one movable metering unit changes its position relative to the dampening roller in an axial direction thereof.

22. The dampening unit according to claim 21, wherein each of the plural metering units are configured to be movable relative to the dampening roller in the axial direction thereof.

23. The dampening unit according to claim 21, wherein said each of the plural metering units further comprises a separate drive configured to move said each of the plural metering units in the axial direction relative to the dampening roller.

24. The dampening unit according to claim 22, further comprising a common drive for moving the plural moveable metering units the axial direction relative to the dampening roller.

25. The dampening unit according to claim 24, further comprising a threaded rod driven by the common drive on which the plural movable metering units are supported, wherein a carrier of each metering unit comprises a counterthread corresponding to the threaded rod.

26. The dampening unit according to claim 25, wherein the threaded rod has a plurality of threaded rod sections, each of the plural threaded rod sections having a direction of the thread and pitch configured to mate with a respective counterthread.

27. The dampening unit according to claim 21, wherein an edge section of the dampening solution metering device, adjacent in the axial direction to at least one outer metering unit can be at least partially blocked off by at least one edge blocker.

28. The dampening unit according to claim 27, wherein the at least one outer metering unit and the at least one edge blocker at least partially overlap.

29. The dampening unit according to claim 28, further comprising a plurality of edge blockers, wherein the plural edge blockers are configured to extend telescopically or in or roll-like manner.

30. The dampening unit according to claim 18, wherein the plural metering units are configured as spray units.

31. The dampening unit according to claim 18, wherein the plural metering units are configured as whirlers.

32. A printing couple of a web-fed rotary printing press comprising:
an impression cylinder rolling on the transfer cylinder;
an inking couple configured to apply printing ink to at least one printing form positioned on the form cylinder;
at least one dampening form roller configured to convey dampening solution from a dampening roller train to the at least one printing form, and
a dampening solution metering device configured to apply the dampening solution to at least one dampening roller of the dampening roller train, the dampening roller located directly downstream of the dampening solution metering device, the dampening solution metering device comprising a plurality of metering units, the plural metering units configured to apply the dampening solution based at least in part on the substrate width or the width of the pages to be printed on the substrate,
wherein, the each of the plural metering units is configured to be one of moveable and individually controllable.
